(19) United States
(12) Patent Application Publication
(10) Pub. No.: US 2013/0002388 A1
(43) Pub. Date: Jan. 3, 2013

(54) MULTILAYERED CERAMIC ELECTRONIC COMPONENT AND MANUFACTURING METHOD THEREOF

(75) Inventors: Jong Han KIM, Suwon (KR); Jae Man Park, Suwon (KR); Hyun Chul Jeong, Yongin (KR)

(73) Assignee: SAMSUNG ELECTRO-MECHANICS CO., LTD.

(21) Appl. No.: 13/292,803

(22) Filed: Nov. 9, 2011

(30) Foreign Application Priority Data
Jun. 30, 2011 (KR) 10-2011-0065116

(51) Int. Cl. H01F 5/00; B05D 5/12; H01G 4/12

(52) U.S. Cl. 336/200; 361/321.2; 427/126.2

(57) ABSTRACT

There is provided a multilayered ceramic electronic component capable of securing capacitance by controlling electrode connectivity. The multilayered ceramic electronic component includes: a ceramic main body; and internal electrodes formed in the interior of the ceramic main body and having a central portion and a tapered portion becoming thinner from the central portion toward edges thereof, respectively, wherein the ratio of the area of the tapered portion to the overall area of the internal electrodes is 35% or less. A desired capacitance can be obtained by controlling an electrode connectivity even in the small high capacitance multilayered ceramic capacitor.

### CROSS-REFERENCE TO RELATED APPLICATIONS

This application claims the priority of Korean Patent Application No. 10-2011-0065116 filed on Jun. 30, 2011, in the Korean Intellectual Property Office, the disclosure of which is incorporated herein by reference.

### BACKGROUND OF THE INVENTION

1. Field of the Invention

The present invention relates to a multilayered ceramic electronic component and a manufacturing method thereof and, more particularly, to a multilayered ceramic electronic component capable of securing capacitance by controlling electrode connectivity, and a manufacturing method thereof.

2. Description of the Related Art

Recently, as electronic products have tended to be smaller and lighter, electronic components employed in electronic products have been required to be reduced in size and thickness.

There have been efforts to increase the number of laminations to the maximum possible level by forming thin dielectric layers and thin internal electrode layers or to increase the connectivity of electrodes to the maximum possible level by adjusting the amount of sintering retarder added to the internal electrodes and controlling a firing temperature and atmosphere to thereby secure capacitance.

In case of a small, high-capacitance multilayered ceramic capacitor (MLCC), in order to increase the number of laminations, the thickness of the dielectric layer and that of the internal electrode layer are required to be reduced and an effective electrode area (connectivity or coverage of the internal electrodes) affecting capacitance is of significance.

In the process of drying and leveling internal electrodes after printing the internal electrodes, edge portions of the printed electrode plane become relatively thin, and in this case, as the printed area is smaller or as the internal electrode is printed to be thinner, the fraction of the thin edge portions of the printed electrode plane is increased.

The connectivity of the electrodes at the relatively thin portions is drastically lowered after the firing operation, and so the influence of the edge portions on capacitance is increased in a product or a device which is small or has high capacitance.

As the ceramic dielectric layers are becoming thinner and highly laminated, the volumetric portion of the internal electrode layers is increased, and thus the ceramic laminated body (or ceramic lamination) may be cracked or dielectric breakdown may occur due to a thermal impact applied in a process of mounting on a circuit board, or the like, due to firing, reflow soldering, or the like.

In detail, cracks are caused as stress stemming from the difference in thermal expansion coefficients between a ceramic layer and an internal electrode layer acts on the ceramic lamination, and in particular, cracks are largely generated in both upper and lower edges of the multilayered ceramic capacitor.

In addition, stress may be generated at the uppermost portion and the lowermost portion of the dielectric according to a thermal change, and when voltage is applied at this time, dielectric breakdown may be generated in the dielectric layer.

### SUMMARY OF THE INVENTION

An aspect of the present invention provides a multilayered ceramic electronic component capable of securing capacitance by controlling electrode connectivity, and a manufacturing method thereof.

According to an aspect of the present invention, there is provided a multilayered ceramic electronic component including: a ceramic main body; and internal electrodes formed in the interior of the ceramic main body and having a central portion and a tapered portion becoming thinner from the central portion toward edges thereof, respectively, wherein the ratio of the area of the tapered portion to the overall area of the internal electrodes is 35% or less.

The internal electrodes may include pores, and when the overall area of the internal electrodes including the pores is A, the area of the internal electrodes excluding the pores is B, and B/A is defined as the coverage of the internal electrodes, then, the coverage of the central portion may be 75% or larger.

The coverage of the tapered portion may be 80% or less of the coverage of the central portion.

The size of the multilayered ceramic electronic component may be 0.6 mm×0.3 mm×0.3 mm or smaller.

The ceramic main body may include 200 or more dielectric layers.

The shape of the internal electrodes viewed in a lamination direction may be a rectangular shape, a chamfered rectangular shape, or a rectangular shape with rounded corners.

According to another aspect of the present invention, there is provided a method of manufacturing a multilayered ceramic electronic component, including: preparing a dielectric sheet; preparing a conductive paste; and printing the conductive paste on the dielectric sheet to form an internal electrode having a central portion and a tapered portion becoming thinner toward the edges from the central portion, wherein the ratio of the area of the tapered portion to the overall area of the internal electrode is 35% or less.

The size of the multilayered ceramic electronic component may be 0.6 mm×0.3 mm×0.3 mm or smaller.

In case of the dielectric sheets, 200 or more may be laminated.

The shape of the internal electrodes viewed in a lamination direction may be a rectangular shape, a chamfered rectangular shape, or a rectangular shape with rounded corners.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a multilayered ceramic electronic component according to an embodiment of the present invention;

FIG. 2 is a cross-sectional view taken along line A-A′ in FIG. 1;

FIG. 3(A) is a schematic vertical cross-sectional view of an internal electrode immediately after printing is performed;

FIG. 3(B) is a schematic vertical cross-sectional view of the internal electrode after drying and leveling is performed;

FIG. 4 is a schematic view of an internal electrode of a large chip (a) and that of a small chip (b) in a direction in which the internal electrode is laminated before and after firing is performed; and

FIG. 5 is a modification example of the internal electrode according to an embodiment of the present invention.

### DETAILED DESCRIPTION OF THE INVENTION

Embodiments of the present invention will now be described in detail with reference to the accompanying drawings.

The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

A multilayered ceramic electronic component includes a multilayered ceramic capacitor (MLCC), a chip inductor, chip beads, or the like. The MLCC will be described as an example, but the present invention is not limited thereto.

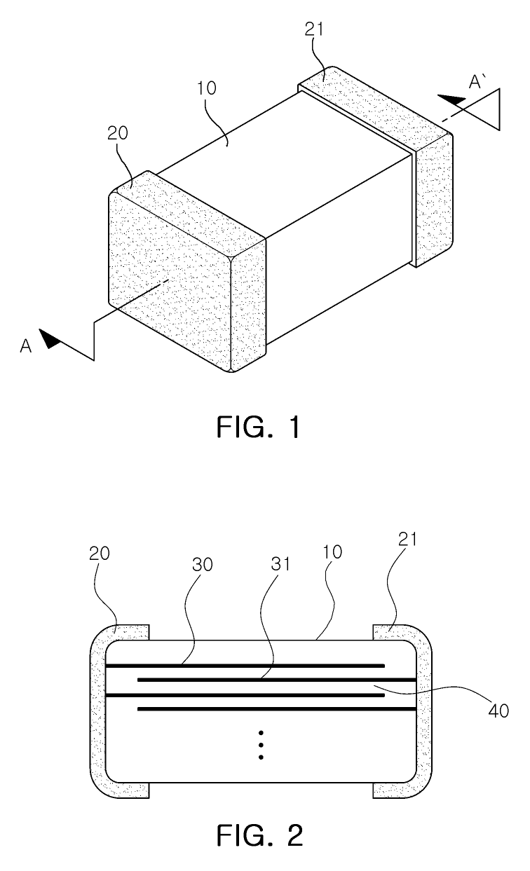

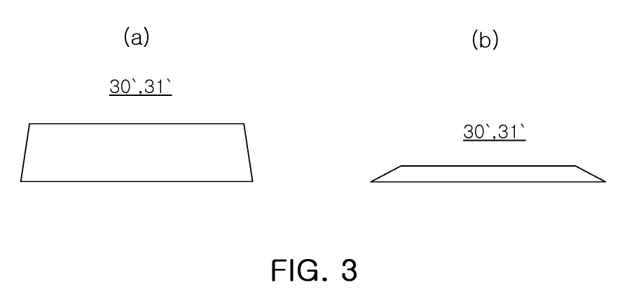

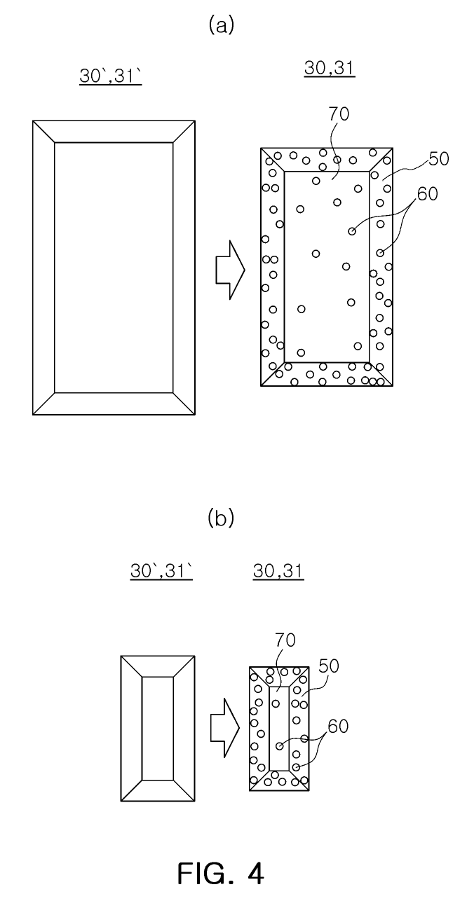

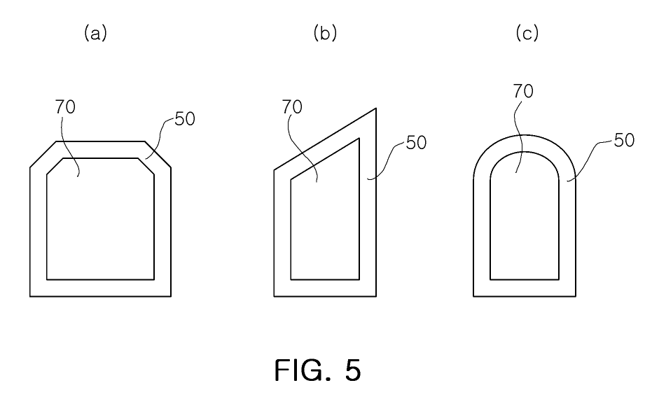

FIG. 1 is a schematic perspective view of a multilayered ceramic electronic component according to an embodiment of the present invention. FIG. 2 is a cross-sectional view taken along line A-A′ in FIG. 1. FIG. 3(A) is a schematic vertical cross-sectional view of an internal electrode immediately after printing is performed. FIG. 3(B) is a schematic vertical cross-sectional view of the internal electrode after drying and leveling is performed. FIG. 4 is a schematic view of an internal electrode (a) having a relatively large area and an internal electrode (b) having a relatively small area before and after firing is performed. FIG. 5 is a modification example of the internal electrode according to an embodiment of the present invention.

A multilayered ceramic electronic component according to an embodiment of the present invention may include a ceramic main body 10, and internal electrodes 30 and 31 formed in the interior of the ceramic main body 10 and having a central portion 70 and a tapered portion 50 becoming thinner from the central portion 70 toward the edges thereof. The ratio of the area of the tapered portion 50 to the overall area of the internal electrodes 30 and 31 may be 35% or less.

The ceramic main body 10 may be formed of a ceramic material having high permittivity, and a barium titanate (BaTiO₃)-based material, a lead-complex perovskite-based material, a strontium titanate (SrTiO₃)-based material, or the like, may be used therefore, but the present invention is not limited thereto.

The ceramic main body 10 may be formed by laminating and then sintering a plurality of ceramic dielectric layers 40, and here, adjacent dielectric layers 40 may be integrated such that boundaries therebetween are not readily recognizable.

The ceramic main body 10 may include 200 or more dielectric layers 40.

When a chip size is large (1.6 mm×0.8 mm×0.8 mm, 1.0 mm×0.5 mm×0.5 mm), the number of laminated dielectric layers 40 and the ratio of the area of the tapered portion 50 to the overall area of the internal electrodes 30 and 31 are not problematic, but when the chip size is small (0.6 mm×0.3 mm×0.3 mm) and the number of laminated dielectric layers 40 exceeds 200, the ratio of the area of the tapered portion 50 to the overall area of the internal electrodes 30 and 31 is problematic (This will be described in detail later with reference to Table 1). Here, the capacitance can be implemented when the ratio of the area of the tapered portion 50 to the overall area of the internal electrodes 30 and 31 is 35% or less.

External electrodes 20 and 21 may be formed of a conductive metal, and here, the conductive metal may include copper (Cu), a copper alloy, nickel (Ni), a nickel alloy, silver, palladium, or the like, but the present invention is not limited thereto.

The external electrodes 20 and 21 may be formed on both end faces of the capacitor main body. Here, the external electrodes 20 and 21 may be electrically connected to the internal electrodes 30 and 31 exposed from end faces of the ceramic main body 10.

The internal electrodes 30 and 31 may be formed such that one end thereof is exposed from an end face of the ceramic main body 10. When one end of any of the internal electrodes 30 is exposed from one face of the ceramic main body 10, one end of a neighboring internal electrode 31 may be exposed from the opposite end face of the ceramic main body 10.

The internal electrodes 30 and 31 may be formed by printing paste including a conductive metal, a binder, and a solvent on a dielectric green sheet and firing the paste.

As the conductive metal, nickel (Ni), a nickel alloy, or the like, may be used.

The conductive paste composition for the internal electrodes may further include a ceramic sintering inhibitor, e.g., barium titanate.

A polymer resin such as polyvinylbutyral, ethylcellulose, or the like, may be used as a binder.

The solvent of the conductive paste for the internal electrodes is not particularly limited, and, for example, terpineol, dehydroterpineol, butylcarbitol, kerosene, or the like, may be used.

The internal electrodes 30 and 31 may be formed on the dielectric green sheet through screen printing, gravure printing, or the like.

The internal electrodes 30 and 31 may include a central portion 70 and a tapered portion 50 becoming thinner toward the edges thereof from the central portion 70.

The internal electrode central portion 70 and the internal electrode tapered portion 50 may be discriminated by the following reference.

The middle portion of the internal electrodes 30 and 31 where uneven depressions and protrusions are present may be defined as the central portion 70, and a portion in which the thickness of the internal electrodes is gradually reduced toward the edges of the internal electrodes 30 and 31 may be defined as the tapered portion 50.

The ratio of the area of the tapered portion 50 to the overall area of the internal electrodes 30 and 31 may be 35% or less.

If the ratio of the area of the tapered portion 50 to the overall area of the internal electrodes 30 and 31 was to exceed 35%, the proportion of the pores 60 among the internal electrodes 30 and 31 would be too increased to implement capacitance.

More pores 60 exist in the internal electrode tapered portion 50 than in other portions of the internal electrodes 30 and 31. Since the internal electrode tapered portion 50 is thinner, it is strongly affected by a firing shrinkage, compared with other portions of the internal electrodes which are relatively thick. Thus, more pores 60 may be formed in the internal electrode tapered portion 50 than in the internal electrode central portion 70.

As electronic components are becoming smaller and lighter, internal electrodes have tended to become smaller, and as electronic components increasingly have higher capacitance, the thickness of internal electrodes has tended to be reduced. However, although the size of the internal electrodes 30 and 31 is reduced, the width of the internal electrode tapered portion 50 is substantially fixed or regular, so as the size of the internal electrodes 30 and 31 is reduced, the fraction of the tapered portion 50 among the internal electrodes 30 and 31 is increased. As the proportion of the tapered portion 50 is increased, more pores 60 are present in the entire internal electrodes 30 and 31, potentially leading to a difficulty in implementing capacitance.

Coverage of the central portion 70 of the internal electrodes 30 and 31 may be 75% or greater.

The coverage of the internal electrodes 30 and 31 may be defined as follows.

Namely, when the overall area of the internal electrodes 30 and 31 including the pores 60 formed in the internal electrodes 30 and 31 is A and the overall area of the internal electrodes 30 and 31 excluding the pores 60 is B, B/A may be defined as the coverage of the internal electrodes.

When the coverage of the internal electrodes 30 and 31 is relatively large, it means that the internal electrodes 30 and 31 are formed to have little empty space therein, so a high electrostatic capacitance can be secured, but conversely, when the coverage of the internal electrodes 30 and 31 is relatively small, since the effective face forming the electrostatic capacitance is reduced, the small coverage of the internal electrodes 30 and 31 may have a difficulty in forming electrostatic capacitance.

When the coverage of the central portion 70 of the internal electrodes 30 and 31 is less than 75%, it may be difficult to implement capacitance.

FIG. 3(A) is a schematic vertical cross-sectional view of an internal electrode immediately after printing has been performed, and FIG. 3(B) is a schematic vertical cross-sectional view of the internal electrode after drying and leveling has been performed.

With reference to FIGS. 3(A) and 3(B), the section of the internal electrodes 30 and 31 immediately after the printing is close to a rectangular form (FIG. 3(A)), but the thickness is considerably reduced after the drying and leveling to form the central portion 70 and the tapered portion 50 becoming thinner toward the edges thereof from the central portion 70 (FIG. 3(b)).

A volatile matter is easily volatilized at the edges of the printed internal electrodes 30′ and 31′, so the cross-section of the internal electrodes 30′ and 31′ after the drying and leveling may have the tapered shape in which the internal electrodes 30′ and 31′ become thinner toward the edges.

With reference to FIG. 4, when the internal electrodes 30′ and 31′ including the central portion 70 and the tapered portion 50 are fired, the size of the internal electrodes 30 and 31 is reduced due to firing shrinkage, or the like, and the pores 60 are formed in the interior of the internal electrodes 30 and 31.

In the present embodiment, the internal electrodes 30 and 31 have a rectangular shape, but the present invention is not limited thereto and the internal electrodes 30 and 31 may have various other shapes such as a chamfered rectangular shape, a rectangular shape with rounded corners, or the like.

More pores 60 may be formed at the tapered portion 50 of the internal electrodes.

The coverage of the internal electrode tapered portion 50 may be smaller than the coverage of the internal electrode central portion 70, and the coverage of the internal electrode tapered portion 50 may be 80% or less of the coverage of the internal electrode central portion 70.

The internal electrode central portion 70 and the internal electrode tapered portion 50 may be formed of the same material, so they may be shrunk with the same degree of firing shrinkage in the firing process. However, since the thickness of the internal electrode tapered portion 50 is less, the internal electrode tapered portion 50 is more affected by the firing shrinkage, and thus, more pores 60 may be formed at the tapered portion 50 of the internal electrodes. This phenomenon may be conspicuous as thickness is reduced.

When the thickness of the internal electrode central portion 70 is increased, the thickness of the internal electrode tapered portion 50 is also increased, and when the thickness of the internal electrode central portion 70 is decreased, the thickness of the internal electrode tapered portion 50 is also decreased. Namely, it can be considered that the ratio of the thickness of the internal electrode central portion 70 to that of the internal electrode tapered portion 50 may be substantially constant.

Since the thickness of the internal electrodes 30 and 31 is a major factor affecting the generation of the pores 60 due to the firing shrinkage, so a relative ratio of the number of the pores 60 generated after the firing operation may be substantially constant at the internal electrode central portion 70 and the internal electrode tapered portion 50. Namely, the relative ratio between the coverage of the internal electrode central portion 70 and that of the internal electrode tapered portion 50 may be substantially constant.

The coverage ratio of the internal electrode tapered portion 50 to that of the internal electrode central portion 70 may be 80% or less.

The coverage of the internal electrode central portion 70 and that of the internal electrode tapered portion 50 may be controlled by adjusting rheology of the paste for the internal electrodes.

As the viscosity of the paste for the internal electrodes becomes less, the coverage of the internal electrodes 30 and 31 may be degraded, or as the content of an additive such as a binder, or the like, becomes less, the coverage of the internal electrodes 30 and 31 may be degraded.

As particles of a conductive metal are smaller, a surface area of the conductive metal particles is increased and the conductive metal particles tend to cluster, increasing the viscosity of the paste, and as the content of the binder is decreased, the bonding between the conductive metals is increased, increasing the viscosity of the paste.

Internal electrodes printed with paste having high viscosity may be formed to be relatively thick, while, internal electrodes printed with paste having low viscosity may be formed to be relatively thin. Thus, as the viscosity of the paste is reduced, the frequency of formation of the pores 60 is increased and the coverage may be degraded.

When the internal electrodes 30′ and 31′ printed with paste are subjected to a debinder process, organic substances such as the solvent, the binder, or the like, existing in the paste, may be volatilized to be removed, and as the internal electrodes 30′ and 31′ are subjected to a firing process, the conductive metal particles may be densified to cause a firing shrinkage, and here, when a larger amount of the volatile material, which is removed in the debinder process, is present, more pores 60 may be formed in the fired internal electrodes 30 and 31, and the coverage may be degraded.

A method of manufacturing a multilayered ceramic electronic component according to an embodiment of the present invention may include: preparing a dielectric sheet; preparing a conductive paste; and printing the conductive paste on the dielectric sheet to form an internal electrode having a central portion 70 and a tapered portion 50 becoming thinner toward the edges thereof from the central portion 70, wherein the ratio of the area of the tapered portion to the overall area of the internal electrode may be 35% or less.

The method of manufacturing a multilayered ceramic capacitor according to an embodiment of the present invention will now be described.

A ceramic powder, such as barium titanate, a binder, a solvent, and the like, may be mixed and dispersed through a method such as a ball mill method, or the like, to manufacture a ceramic slurry, and a dielectric green sheet having a thickness of about a few micro-meter (um) may be manufactured by using the ceramic slurry through a doctor blade method.

After a conductive metal such as nickel (Ni), a binder, a solvent, and the like, are mixed, a conductive paste for an internal electrode may be manufactured through a 3-roll ball mill. As the binder, a resin such as ethylcellulose, polyvinylbutyral, or the like, may be used, but the present invention is not limited thereto. As the solvent of the conductive paste composition for internal electrodes, terpineol, dehydroterpineol, butylcarbitol, kerosene, or the like, may be used, but the present invention is not particularly limited thereto.

The conductive paste for internal electrode is printed on the dielectric green sheet through a method such as screen printing, or the like, to form internal electrodes, and internal electrodes are laminated, pressed, and cut to manufacture a chip. After the chip is fired, external electrodes and a plated layer are formed to manufacture a multilayered ceramic capacitor.

Matters related to the central portion and the tapered portion of the internal electrode, matters related to the size of the multilayered ceramic electronic component, matters related to the number of laminated dielectric layers, and matters related to the shape of the internal electrode may be the same as described above.

### Example

Barium titanate powder was used as a main material and mixed with a binder, a solvent, and the like, to manufacture a dielectric slurry, and the dielectric slurry was then applied to a carrier film through a doctor blade method to manufacture a dielectric green sheet having a thickness of 10 um.

As conductive paste for forming an internal electrode, nickel (Ni) powder having an average particle size of 0.1 um was used, and here, the content of nickel (Ni) was 40% to 50%.

The nickel (Ni) powder was dispersed by using a 3-roll ball mill.

The conductive paste was printed on the dielectric green sheet through a screen printing method to form an internal electrode having a thickness of 0.7 μm.

The dielectric green sheet with the internal electrode formed thereon was laminated, pressed and cut to manufacture a chip, which was subjected to a debinder process at 230□ for 60 hours, and then, fired at a reduction atmosphere under an oxygen partial pressure of 10⁻¹¹˜10⁻¹⁰, lower than an Ni/NiO equilibrium oxygen partial pressure, at 1200□, such that the internal electrodes were not oxidized.

An average thickness of the internal electrodes 30 and 31 of the laminated ceramic capacitor was 0.6 μm to 0.7 μm, and the thickness of the dielectric layer 40 was 0.7 μm to 0.8 μm.

Table 1 below shows the results of evaluation as to how the capacitance of the multilayered ceramic capacitor (MLCC) was implemented according to the chip size of the MLCC, the number of laminated dielectric layers 40, and the ratio of the area of the internal electrode tapered portion 50 to the overall area of the internal electrodes 30 and 31.

The implementation of the capacitance of the MLCC was determined based on whether or not 100% of a design value was achieved.

TABLE 1

| | | | Ratio (%) of area of | |
|---|---|---|---|---|
| | | | tapered portion to | |
| Test | | Lamination | overall area of | Implementation of |
| sample | Chip size | number | internal electrodes | capacitance |
| 1* | 1.6 mm × 0.8 mm × 0.8 mm | 254 | 12.1 | ∘ |
| 2* | 1.6 mm × 0.8 mm × 0.8 mm | 507 | 21.3 | ∘ |
| 3* | 1.0 mm × 0.5 mm × 0.5 mm | 233 | 20.5 | ∘ |
| 4* | 1.0 mm × 0.5 mm × 0.5 mm | 417 | 33.4 | ∘ |
| 5* | 0.6 mm × 0.3 mm × 0.3 mm | 155 | 41.3 | ∘ |
| 6* | 0.6 mm × 0.3 mm × 0.3 mm | 202 | 43.7 | x |
| 7 | 0.6 mm × 0.3 mm × 0.3 mm | 202 | 34.8 | ∘ |
| 8 | 0.6 mm × 0.3 mm × 0.3 mm | 202 | 30.7 | ∘ |
| 9* | 0.6 mm × 0.3 mm × 0.3 mm | 234 | 36.4 | x |
| 10 | 0.6 mm × 0.3 mm × 0.3 mm | 234 | 28.7 | ∘ |
| 11* | 0.6 mm × 0.3 mm × 0.3 mm | 257 | 35.3 | x |
| 12 | 0.6 mm × 0.3 mm × 0.3 mm | 257 | 31.3 | ∘ |

*Comparative example
∘: Good
x: Poor

With reference to Table 1, it was confirmed that test samples 1 to 4 had a large chip size (1.6 mm×0.8 mm×0.8 mm, 1.0 mm×0.5 mm×0.5 mm), so although the number of laminated dielectric layers 40 was large, the ratio of the area of the tapered portion 50 to the overall area of the internal electrodes 30 and 31 was less than 35%, and thus, capacitance was implemented without any difficulties.

As for test sample 5, it is noted that the chip size was reduced (0.6 mm×0.3 mm×0.3 mm) and the ratio (41.3%) of the area of the tapered portion 50 to the overall area of the internal electrodes 30 and 31 exceeded 35%, but since the number of laminated dielectric layers 40 was 155, a relatively small amount, there were no difficulties in implementing capacitance.

As for test sample 6, it is noted that the ratio (43.7%) of the area of the tapered portion 50 to the overall area of the internal electrodes 30 and 31 exceeded 35% and the number of laminated dielectric layers 40 was increased to 202, failing to implement capacitance.

As for test samples 9 and 11, the chip size was 0.6 mm×0.3 mm×0.3 mm and the lamination numbers of the dielectric layers 40 were 234 and 257, respectively, which exceeded 200, ending in the failure of the implementation of capacitance.

The results can be inferred from the fact that the ratios of the area of the tapered portion 50 to the overall area of the internal electrodes 30 and 31 were 36.4% and 35.3%, respectively, which exceeded 35%.

As for test samples 7, 8, 10, and 12, the chip size was 0.6 mm×0.3 mm×0.3 mm and the lamination numbers of the dielectric layers 40 were 202, 202, 234, and 257, respectively, which exceeded 200, but since the ratios of the area of the tapered portion 50 to the overall area of the internal electrodes 30 and 31 were 34.8%, 30.7%, 28.7%, and 31.3%, respectively, which did not exceed 35%, capacitance could be implemented.

To sum up, the results of Table 1 show that when the chip size was large (i.e., 1.6 mm×0.8 mm×0.8 mm, 1.0 mm×0.5 mm×0.5 mm), the number of laminated dielectric layers 40 and the ratio of the area of the tapered portion 50 to the overall area of the internal electrodes 30 and 31 did not matter, but when the chip size was small (i.e., 0.6 mm×0.3 mm×0.3 mm) and the lamination number of dielectric layers 40 exceeded 200, the ratio of the area of the tapered portion 50 to the overall area of the internal electrodes 30 and 31 is an issue, and here, when the ratio of the area of the tapered portion 50 to the overall area of the internal electrodes 30 and 31 is 35% or less, capacitance could be implemented.

Table 2 below shows the results of evaluation of the implementation of capacitance while changing the coverage of the internal electrode central portion 70 and the ratio of the area of the tapered portion 50 to the overall area of the internal electrodes 30 and 31 when the chip size was small (i.e., 0.6 mm×0.3 mm×0.3 mm) and the number of laminated dielectric layers 40 was 202.

TABLE 2

| | | | | Ratio of area of | |
|---|---|---|---|---|---|
| | | | Coverage of | tapered portion to | |
| Test | | Lamination | internal electrode | area of internal | Implementation of |
| sample No. | Chip size (mm) | number | central portion (%) | electrodes (%) | capacitance |
| 1* | 0.6 mm × 0.3 mm × 0.3 mm | 202 | 72.3 | 37.7 | x |
| 2* | 0.6 mm × 0.3 mm × 0.3 mm | 202 | 74.7 | 33.5 | x |
| 3 | 0.6 mm × 0.3 mm × 0.3 mm | 202 | 75.5 | 34.5 | ∘ |
| 4* | 0.6 mm × 0.3 mm × 0.3 mm | 202 | 77.8 | 38.8 | x |
| 5 | 0.6 mm × 0.3 mm × 0.3 mm | 202 | 80.2 | 33.3 | ∘ |
| 6 | 0.6 mm × 0.3 mm × 0.3 mm | 202 | 83.8 | 30.2 | ∘ |
| 7 | 0.6 mm × 0.3 mm × 0.3 mm | 202 | 85.3 | 29.8 | ∘ |
| 8 | 0.6 mm × 0.3 mm × 0.3 mm | 202 | 87.7 | 27.6 | ∘ |

*Comparative example
∘: Good
x: Poor

With reference to Table 2, as for test samples 3, 5 to 8, the coverage of the internal electrode central portion 70 was 75% or more and the ratio of the area of the internal electrode tapered portion 50 to the overall area of the internal electrodes 30 and 31 was 35% or less, implementing capacitance.

As for test sample 1, the ratio (37.7%) of the area of the internal electrode tapered portion 50 to the overall area of the internal electrodes 30 and 31 exceeded 35% and the coverage (72.3%) of the internal electrode central portion 70 was smaller than 75%. Since the coverage of the central portion 70 and that of the tapered portion 50 of the internal electrodes 30 and 31 are low, it can be inferred that the capacitance was not implemented.

As for test sample 2, the ratio (33.5%) of the area of the internal electrode tapered portion 50 to the overall area of the internal electrodes 30 and 31 was less than 35%, and the coverage (74.7%) of the internal electrode central portion 70 was less than 75%. Since the coverage of the internal electrode central portion 70 was low, it can be inferred that capacitance was not implemented.

As for the test sample 4, the coverage (77.8%) of the internal electrode central portion 70 was larger than 75% and the ratio (38.8%) of the area of the internal electrode tapered portion 50 to the overall area of the internal electrodes 30 and 31 is larger than 35%. Since the coverage of the tapered portion was low, it can be inferred that the capacitance was not implemented.

To sum up, in case in which the chip size was small (i.e., 0.6 mm×0.3 mm×0.3 mm) and the number of laminated dielectric layers 40 was 202, when the coverage of the internal electrode central portion 70 was 75% or larger and the ratio of the area of the internal electrode tapered portion 50 to the overall area of the internal electrodes 30 and 31 was 35% or less, capacitance could be implemented.

As set forth above, according to embodiments of the invention, in the multilayered ceramic electronic component, high capacitance can be obtained by controlling electrode connectivity.

While the present invention has been shown and described in connection with the embodiments, it will be apparent to those skilled in the art that modifications and variations can be made without departing from the spirit and scope of the invention as defined by the appended claims.

What is claimed is:

1. A multilayered ceramic electronic component comprising:
a ceramic main body; and
internal electrodes formed in the interior of the ceramic main body and having a central portion and a tapered portion becoming thinner from the central portion toward edges thereof, respectively,
the ratio of the area of the tapered portion to the overall area of the internal electrodes being 35% or less.

2. The multilayered ceramic electronic component of claim 1, wherein the internal electrodes include pores, and when the overall area of the internal electrodes including the pores is A, the area of the internal electrodes excluding the pores is B, and B/A is defined as the coverage of the internal electrodes, then, the coverage of the central portion is 75% or larger.

3. The multilayered ceramic electronic component of claim 1, wherein the coverage of the tapered portion is smaller than that of the central portion.

4. The multilayered ceramic electronic component of claim 1, wherein the coverage of the tapered portion is 80% or less of the coverage of the central portion.

5. The multilayered ceramic electronic component of claim 1, having the size is 0.6 mm×0.3 mm×0.3 mm or smaller.

6. The multilayered ceramic electronic component of claim 1, wherein the ceramic main body includes 200 or more dielectric layers.

7. The multilayered ceramic electronic component of claim 1, wherein the shape of the internal electrodes viewed in a lamination direction is a rectangular shape, a chamfered rectangular shape, or a rectangular shape with rounded corners.

8. A method of manufacturing a multilayered ceramic electronic component, the method comprising:
preparing a dielectric sheet;
preparing a conductive paste; and
printing the conductive paste on the dielectric sheet to form an internal electrode having a central portion and a tapered portion becoming thinner toward the edges from the central portion,
the ratio of the area of the tapered portion to the overall area of the internal electrode being 35% or less.

9. The method of claim 8, wherein the size of the multilayered ceramic electronic component is 0.6 mm×0.3 mm×0.3 mm or smaller.

10. The method of claim 8, wherein the dielectric sheets are provided as 200 or more laminations.

11. The method of claim 8, wherein the sectional shape of the internal electrodes viewed in the lamination direction is a rectangular shape, a chamfered rectangular shape, or a rectangular shape with rounded corners.
